(19) United States
(12) Patent Application Publication
(10) Pub. No.: US 2004/0028564 A1
(43) Pub. Date: Feb. 12, 2004

(54) Pipette with tip ejector

(76) Inventor: Francois Viot, Auvers-sur-Oise (FR)

Correspondence Address: PHILIP M. KOLEHMAINEN, GREER, BURNS & CRAIN, LTD., SUITE 2500, 300 SOUTH WACKER DRIVE, CHICAGO, IL, 60606, US

(21) Appl. No.: 10/240,985

(22) PCT Filed: Apr. 9, 2001
(86) PCT No.: PCT/FR01/01073

(30) Foreign Application Priority Data
Apr. 7, 2000 (FR) 00/04471

(51) Int. Cl. B01L 3/02

(52) U.S. Cl. 422/100

(57) ABSTRACT

The sampling pipette includes an ejector arm (14, 20) for separating from the pipette a cone that is fixed to the pipette. The pipette includes adjustment means (16, 18) enabling the length of the arm to be varied continuously over a range of values.

The invention relates to pipettes for taking samples of liquids.

By way of example, document FR-2 696 110 discloses a sampling pipette suitable for receiving a discardable cone at its bottom end that is held on the pipette by friction. The pipette has an ejector that is actuatable by means of a button adjacent to the sampling button. Pressing on that button enables the cone to be pushed away from the pipette when it is desired to change a used cone for a new cone. Nevertheless, a drawback with that pipette is that the ejector is compatible with a single type of cone only. However, it is desirable to be able to use the pipette with cones of different dimensions.

An object of the invention is to provide a pipette in which the ejector is compatible with different types of cone.

In order to achieve this object, the invention provides a sampling pipette comprising an ejector arm for separating from the pipette a cone that is fixed to the pipette, the pipette comprising adjustment means enabling the length of the arm to be varied continuously over a range of values.

The length of the ejector can thus be adjusted as a function of the position on the pipette of the cone in use. The ejector is thus compatible with numerous types of cone.

The invention may also present at least one of the following characteristics:

the arm comprises two arm portions connected to each other by a screw-and-nut connection;

the pipette has a nut-forming part that is prevented from sliding relative to one of the arm portions and that is connected by a screw-to the other arm portion;

the nut-forming part is a knurled wheel that is accessible directly from outside the pipette;

the arm portion slidably fixed relative to the nut-forming part is a bottom arm portion, the other arm portion being a top arm portion; and

the arm comprises a first portion suitable for coming into contact with the cone and a second portion, the two portions being engaged one in the other, enabling the first portion to be separated from the body starting from an operating position by being moved in a direction that is essentially perpendicular to the longitudinal direction of the pipette.

Other characteristics and advantages of the invention appear further from the following description of a preferred embodiment given by way of non-limiting example. In the accompanying drawings:

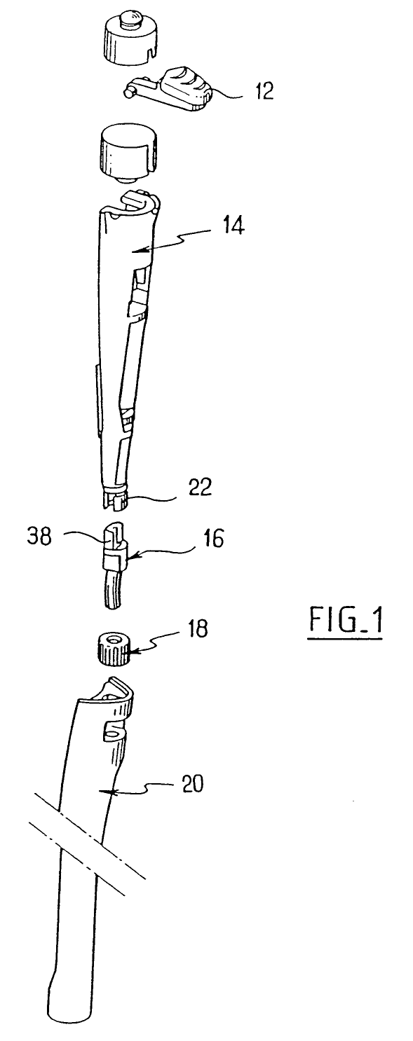

FIG. 1 is a perspective view of the ejector mechanism of a pipette constituting a preferred embodiment of the invention;

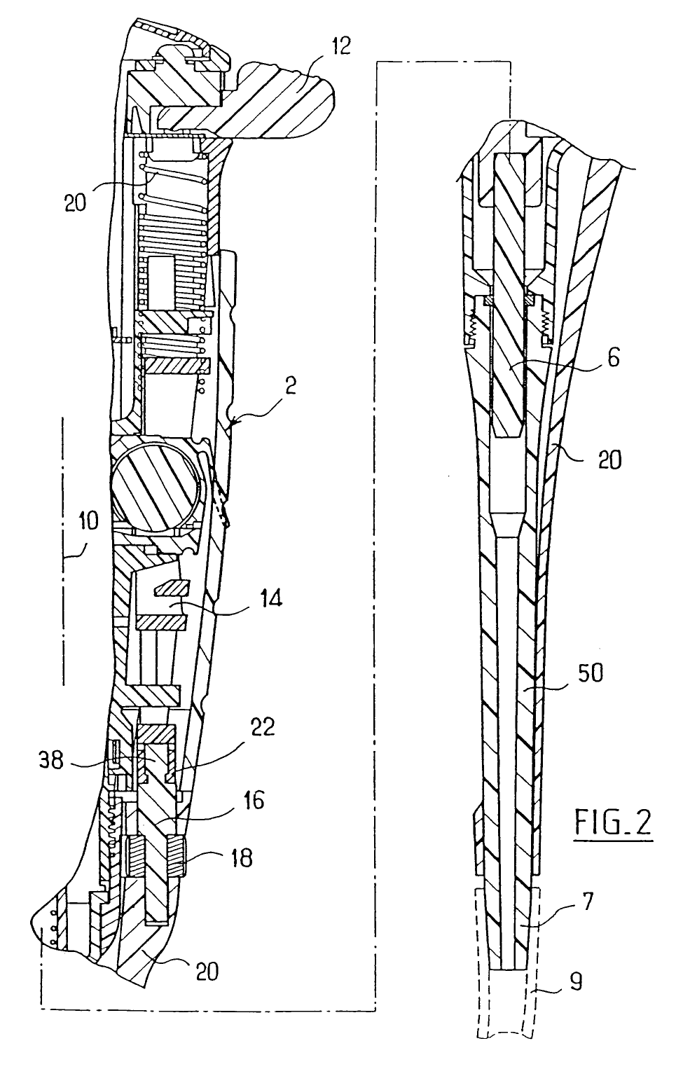

FIG. 2 is a fragmentary axial section view of the pipette showing how the FIG. 1 mechanism is located;

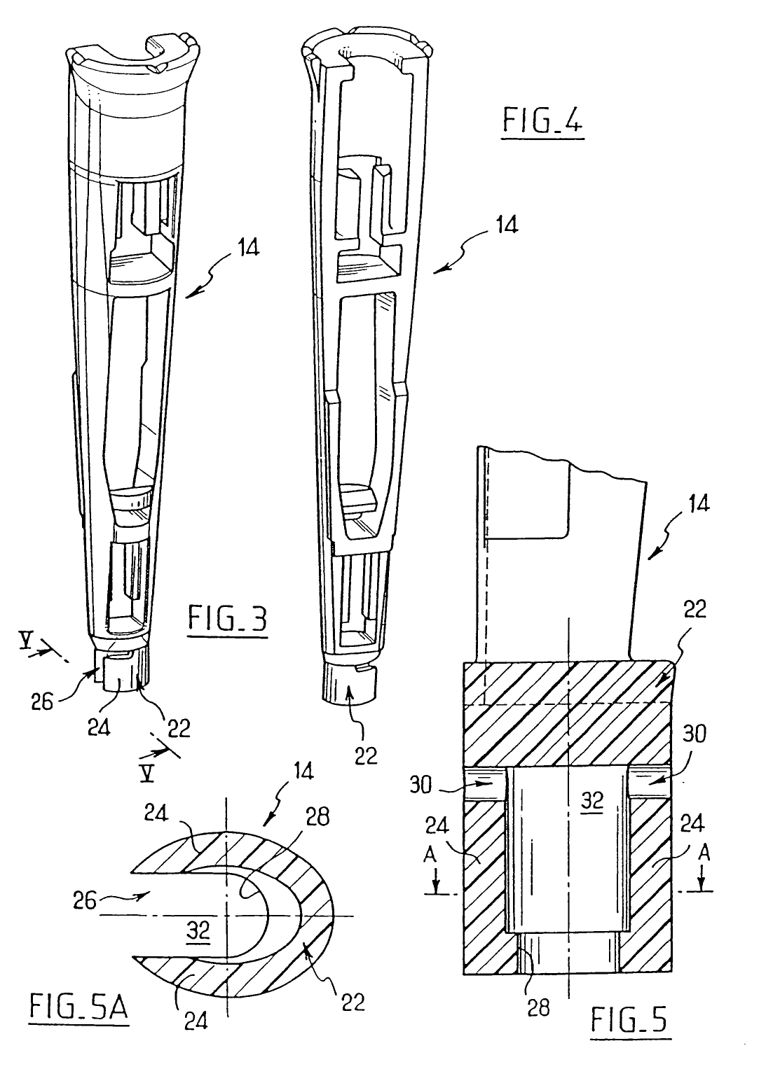

FIGS. 3 and 4 are two perspective views of the actuator of the FIG. 1 mechanism;

FIG. 5 is a fragmentary axial section view of the FIG. 3 actuator on plane VI-VI;

FIG. 5A is an axial section view of the FIG. 5 actuator on plane A-A;

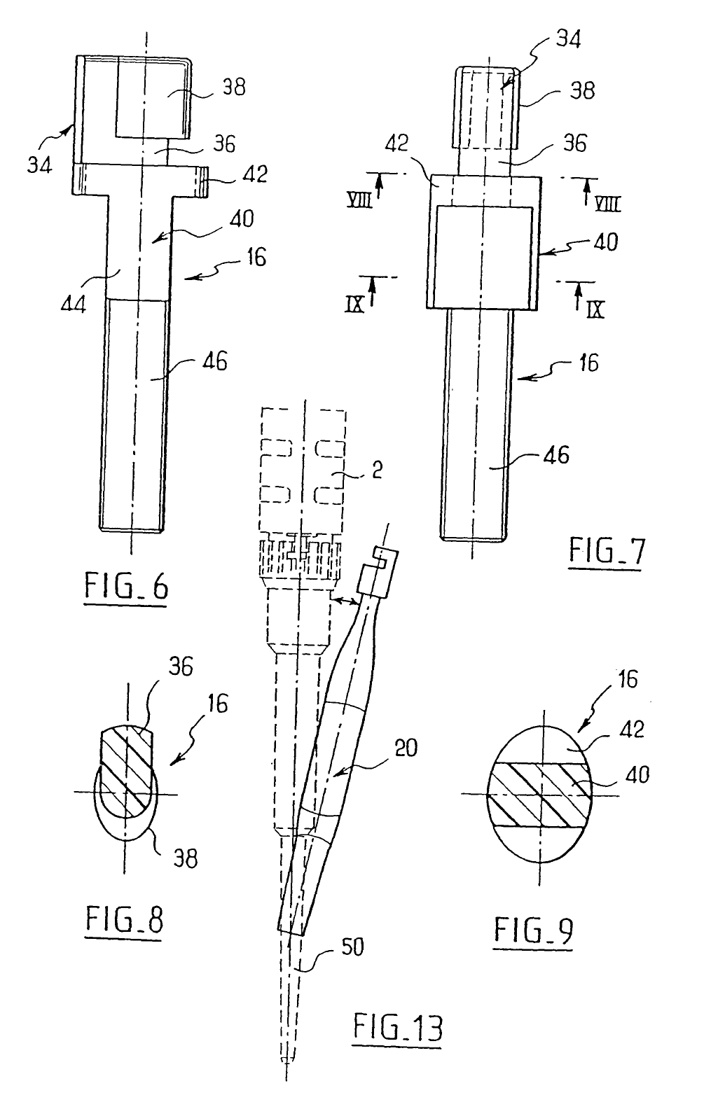

FIGS. 6 and 7 are a rear view and a left-hand view of the connection screw of the FIG. 1 mechanism;

FIGS. 8 and 9 are two cross-section views of the FIG. 7 on planes VIII-VIII and IX-IX;

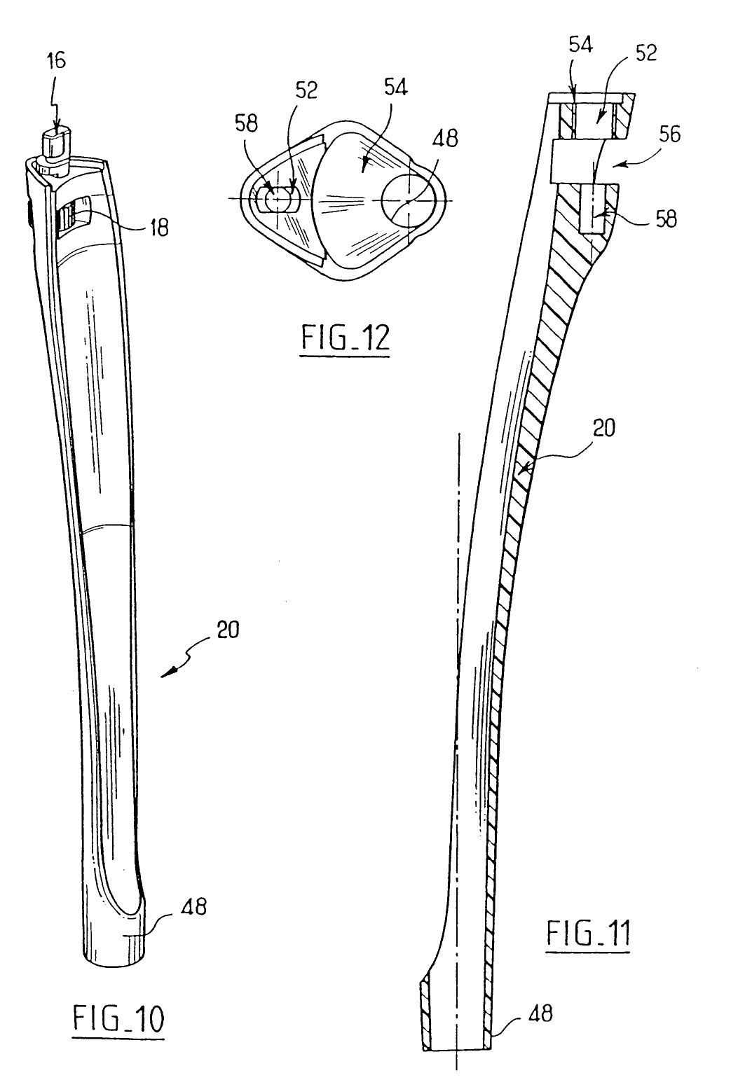

FIGS. 10 and 11 are a perspective view and an axial section view of the ejector rod of the FIG. 1 mechanism;

FIG. 12 is a plan view of the FIG. 10 ejector rod; and

FIG. 13 is a diagram showing how the ejector rod is put into place on the pipette.

The sampling pipette constituting the present embodiment of the invention is of the same type as that disclosed in document FR-2 696 110. Reference can thus be made to that document for certain details of the pipette already disclosed in that document. Only certain aspects of the cone-ejector mechanism are described in detail herein.

With reference to FIG. 2, the pipette 2 conventionally comprises a body 1 serving as a handle to be held in the hand of the user. The pipette has a piston 6 that is slidably movable along a longitudinal axis 10 of the pipette in a bottom cavity of the pipette in order to suck a volume of liquid to be sampled into the pipette or to expel it from said cavity. The movement of the piston is controlled in particular by means of a control rod on the axis 10 connected at its bottom end to the piston by parts of conventional type. The rod is surmounted at its top end by a pushbutton rigidly fixed to the rod and suitable for being actuated by the user using the thumb of the hand that is holding the pipette. The piston thus moves down and up as a function of the corresponding movement of the button. The pipette has a return spring suitable for returning the piston and the rod into a high position at the end of their downward stroke for expelling liquid, and a purge spring that adds its effect to that of the preceding spring when the stroke of the piston is continued downwards for a purge stroke.

The pipette has a bottom clip 7 suitable for receiving in conventional manner a disposable sampling cone 9 which is held to the outside of the bottom clip by friction.

The pipette has a cone-ejector mechanism as shown in FIGS. 1 and 2. Going from top to bottom in the longitudinal direction of the pipette, this mechanism comprises a control button 12, an actuator 14, a connection screw 16, a knurled wheel 18 and an ejector rod 20. The FIG. 1 ejector mechanism extends over the rear portion of the pipette, i.e. the portion which is adjacent to the palm of the user's hand.

The actuator 14 is generally elongate in shape and it tapers going downwards. It is housed in the body 2 of the pipette being slidably movable therein along the axis 10. The pipette is arranged in such a manner that downward pressure on the button 12 causes the actuator 14 to move downwards. The connection between the button and the actuator can be of conventional type and is not described herein. A return spring 20, shown in FIG. 2, serves to raise the actuator 14 when the button 12 is released.

With reference to FIGS. 3, 4, 5, and 5A, the actuator 14 presents a bottom end constituted by a female coupling portion 22. This portion constitutes a section member extending parallel to the axis 10 and has a cross-section that is generally U-shaped, and more precisely it is in the form of a portion of an ellipse with the two limbs 24 of the U-shape coming closer together towards each of their two ends. The opening 26 of the U-shape faces sideways, and in this case towards the left-hand side of the pipette. The bottom edge of the coupling portion 22 has a shoulder forming a step 28 that extends radially towards the inside of the U-shape. Nevertheless, this step is also U-shaped. Each limb 24 is separated from the remainder of the actuator by a horizontal notch 30 extending from a point situated about halfway along the limb to its free end. The coupling portion forms a cavity 32 between the limbs 24.

With reference to FIGS. 6 to 9, the connection screw 16 comprises a top head 34. The head 34 has a support 36 that is generally in the form of a rectangular parallelogram and a male coupling portion 38 suitable for penetrating into the female coupling portion 22 of the actuator. For this purpose, the male coupling portion 38 constitutes a section member extending parallel to the axis 10, and its cross-section transverse to said axis is generally elliptical in shape. The connection screw 16 has a core 40 from which the support 36 extends upwards, being offset laterally relative to the core. The male portion 38 is shorter than the support 36. The top ends of the male portion 38 and of the support 36 are at the same level but the male portion extends at a distance from the core 40 so as to allow the step 28 to pass between them. The male portion 38 extends to the right projecting from the support 36, and likewise it extends forwards and to the rear. In left-hand and right-hand view its profile is T-shaped.

The male portion 38 is suitable for being received by engagement in the female portion 22 by being moved laterally perpendicularly to the axis 10. While insertion is taking place, the limbs 54 spread apart and then move back towards each other, thus generating a click indicting that the male portion has reached a reception position. The limbs are made bendable by the notches 30 and by the material used which in this case is a thermoplastic. The step 38 occupies a position between the male portion 38 and the cone 40. The connection screw 16 is thus rigidly secured to the actuator 14. This connection can be disassembled. Assembly and disassembly are performed by moving the screw in translation relative to the actuator in a left-right lateral direction.

The cone 40 of the connection screw has a flat top plate 42 and a thin bottom portion 44 of essentially rectangular profile. It is extended at its bottom end by a threaded shank 46.

With reference to FIGS. 10 to 12, the ejector rod 20 is elongate in the vertical direction. Its transverse profile is essentially hollow and open. Nevertheless, this profile is closed at the bottom end 48 of the rod so as to form a ring that is slidably engaged on a bottom endpiece 50 of the body 2 forming the free end 7, as shown in FIG. 2. This ring is suitable for coming into direct contact with the cone in order to eject it. Furthermore, the rod 20 is essentially non-rectangular in shape so as to establish a junction between said bottom end 48 lying on the axis 10 of the pipette and the rear portion of the pipette at the top end of the rod which is off-center relative to the axis 10.

At this top end, the rod presents a top vertical duct 52 of rectangular cross-section extending from a top face 54 of the rod to a notch 56 extending horizontally into the rod from its rear face towards its front face. Beneath the notch, the rod presents a bottom duct 58 axially in line with the top duct 52, but this time of circular cross-section. The diameter of the bottom duct 58 is equal to the width of the section of the top duct 52, and likewise the diameter of the threaded shank 46 of the screw 16 is equal to the width of the bottom portion 44 of the support.

The knurled wheel 18 has a central thread bore for forming a screw-and-nut connection with the shank 46 of the screw 16.

The knurled wheel 18 is received in the notch 56 on the same axis as the ducts 52 and 58. The screw 16 penetrates through both ducts and through the knurled wheel. The male portion 38 projects from the top face 54, the rectangular portion 44 of the support housed in the top duct 52 prevents the rod 20 from rotating relative to the screw but allows them to slide relative to each other. The knurled wheel 18 forms a screw-and-nut connection with the shank 46 of the screw. The bottom portion of the screw shank is slidably received in the bottom duct 58. The rod 20 is thus connected to the pipette firstly by the connection screw 16 and secondly by the ring 48 engaged on the endpiece.

The knurled wheel 18 is directly accessible to the user from the rear side of the pipette through the notch. Turning the knurled wheel causes the rod 20 to slide up or down relative to the body 2 parallel to the axis 10 so as to adjust its position as a function of the type of disposable cone used.

To eject the cone, the button 12 is lowered until the rod 20 is at the bottom end of its stroke, thereby pushing the cone downwards and detaching it from the pipette.

When the ejector mechanism is at rest, i.e. at the top end of its stroke, the male and female portions 38 and 22 are housed in the body 2 of the pipette where they are inaccessible to the user. Furthermore, they are protected therein against shocks and dirt. The rod 20 cannot be removed in this position.

To remove the rod 20 and separated it from the pipette, the button 12 is lowered so as to place the rod at the bottom end of its stroke. The male and female portions are then visible. The rod 20 is then moved sideways to separate the male and female portions as described above and as shown in FIG. 13. This causes the rod 20 to be tilted relative to the body of the pipette, with such tilting being made possible by clearance at the ring 48. Thereafter, the bottom portion of the rod is caused to slide downwards so as to be disengaged from the pipette. Reassembly is performed by following the operations in reverse order. The rod 20 can be installed and removed without effort, unlike the longitudinal friction connection known in the prior art.

It can thus be seen that the rod 20, the knurled wheel 18, and the screw 16 constitute a first portion of the ejector arm that is suitable for being engaged laterally in the second portion of the arm as constituted by the actuator.

It should be observed that the rod can be disassembled in this embodiment by turning the knurled wheel until it becomes disengaged from the connection screw 16. However that would separate the rod 20, the screw 16, and the knurled wheel 18 from one another, whereas the procedure as described above keeps these three parts connected together.

Because of the step 28, the rod 20 cannot be separated from the actuator 14 by sliding parallel to the axis 10. It is necessary to begin by separating them by relative lateral movement. There is therefore no fear of untimely separation occurring while ejecting a cone.

The knurled wheel 18 serves to adjust the length of the ejector arm constituted by the actuator 14 and the rod 20, over a continuous range of length values.

Naturally, numerous modifications can be applied to the invention without going beyond the ambit thereof.

For example, the rod 20 could be connected to the actuator 14 using other types of connection that form an obstacle to relative sliding between the parts of the ejector, e.g. one or more screw-and-nut connections or a bayonet connection.

The characteristics concerning adjustment of arm length over a continuous range of values can be implemented independently of the characteristics concerning the two arm portions that are engaged one in the other so as to be separable in a direction perpendicular to the longitudinal direction.

1/ A sampling pipette comprising an ejector arm (14, 20) for separating from the pipette a cone (9) that is fixed to the pipette, the pipette being characterized in that it includes adjustment means (16, 18) enabling the length of the arm to be varied continuously over a range of values.

2/ A pipette according to claim 1, characterized in that the arm comprises two arm portions (14, 20) connected to each other by a screw-and-nut connection.

3/ A pipette according to claim 1 or claim 2, characterized in that it includes a nut-forming part (18) that is prevented from sliding relative to one of the arm portions (20) and that is connected by a screw (16) to the other arm portion.

4/ A pipette according to claim 3, characterized in that the nut-forming part is a knurled wheel (18) that is accessible directly from outside the pipette.

5/ A pipette according to claim 3 or claim 4, characterized in that the arm portion (20) slidably fixed relative to the nut-forming part (18) is a bottom arm portion, the other arm portion (14) being a top arm portion.

6/ A pipette according to any one of claims 1 to 5, characterized in that the arm comprises a first portion suitable for coming into contact with the cone (9) and a second portion, the two portions being engaged one in the other, enabling the first portion to be separated from the body starting from an operating position by being moved in a direction that is essentially perpendicular to the longitudinal direction of the pipette.
